(19) United States
(12) Patent Application Publication
(10) Pub. No.: US 2011/0246052 A1
(43) Pub. Date: Oct. 6, 2011

(54) CONGESTION LEVEL DISPLAY APPARATUS, CONGESTION LEVEL DISPLAY METHOD, AND CONGESTION LEVEL DISPLAY SYSTEM

(75) Inventor: Tomoyuki ZAITSU, Okazaki (JP)

(73) Assignee: AISIN AW CO., LTD., Aichi-ken (JP)

(21) Appl. No.: 13/012,411

(22) Filed: Jan. 24, 2011

(30) Foreign Application Priority Data
Mar. 31, 2010 (JP) 2010-084697

(51) Int. Cl. G08G 1/00; G01C 21/26

(52) U.S. Cl. 701/118

(57) ABSTRACT

In a congestion level display apparatus for a vehicle, a correlation between a traveling speed and a congestion level sent from a traffic center is learnt when the vehicle is travelling within a home area. When the vehicle is traveling outside the home area, the learned correlation is used, by the congestion level display apparatus and in relation to the traveling speed, to display a learned congestion level, instead of the congestion level sent from the traffic center.

### RELATED APPLICATION(S)

The disclosure of Japanese Patent Application No. 2010-084697 filed on Mar. 31, 2010 including the claims, specification, drawings and abstract is incorporated herein by reference in its entirety.

### BACKGROUND

1. Technical Field

The present disclosure relates to a congestion level display apparatus, a congestion level display method, and a congestion level display system.

2. Related Art

As a technology for providing a traffic status of a road to an on-vehicle apparatus, such as a navigation apparatus, a Vehicle Information and Communication System (VICS: registered trademark) is known, for example. The VICS transmits congestion information of a road, a necessary time in a predetermined section, a traffic obstruction such as construction, traffic restriction information such as road closure, and parking area information including availability, and so on, to the on-vehicle apparatus via FM multiplex broadcasting, various types of beacons, and the like. Among them, the congestion information includes information of “heavy congestion”, “light congestion”, and “no congestion” in descending order of congestion levels of roads, that is, congestion levels according to types of roads and traveling speeds of vehicles. Different colors are correlated with this information, for example, “red” with “heavy congestion”, “orange” with “light congestion”, and “blue” with “no congestion”. As described in Japanese Patent Application Publication No. JP-A-H9-133537, for example, in an on-vehicle apparatus which has received the congestion information from the VICS, the congestion information of respective roads is displayed as the colors indicating the congestion levels as described above on a display unit included in the on-vehicle apparatus.

### SUMMARY

The vehicle speeds for classifying the congestion levels often differ depending not only on types of roads but also on regions where the roads exist. For example, between a region A and a region B where road congestion occurs more frequently than in the region A, vehicle speeds for determining “heavy congestion” and “light congestion” are set in a wider range or higher range in the region A even for the same ordinary road. Accordingly, for example, when a driver who usually drives a vehicle in the region A drives his/her own vehicle in the region B, there frequently occurs a situation that a road status which the driver habitually recognizes as “heavy congestion”, “light congestion”, or “no congestion” differs from the congestion information displayed on the on-vehicle apparatus. As a consequence, due to such a difference, the driver recognizes a sense of discomfort about the above-described displayed congestion information, and furthermore, usefulness of the congestion information displayed on the on-vehicle apparatus for this driver decreases.

The present invention is made in view of the above-described situation, and it is an object of the present invention to provide a congestion level display apparatus, a congestion level display method, and a congestion level display system capable of reducing the sense of discomfort which is recognized by a driver about a displayed congestion level.

Hereinafter, means for solving the problems described above and operations and effects thereof will be described.

According to a first aspect of the present invention, a congestion level display apparatus is mounted in a vehicle for displaying a congestion level indicating a congestion status of a predetermined section of a road, the congestion status correlated with speed information related to a traveling speed when the vehicle travels the predetermined section. The apparatus includes: a receiving unit that receives the speed information and the congestion level sent from an outside unit; a position detecting unit that detects a current position of the vehicle; a home area obtaining unit that obtains a home area which the vehicle travels more frequently than other traveling areas; a determining unit that determines whether the current position is within the home area; a congestion level learning unit that learns the speed information of the vehicle traveling the predetermined section and a congestion level in the predetermined section sent from the outside unit in a correlated manner when the current position is within the home area; and a display control unit that displays the congestion level sent from the outside unit when the current position is within the home area and displays a congestion level learned by the congestion level learning unit corresponding to the speed information sent from the outside unit of the vehicle when the current position is not within the home area.

According to the first aspect of the present invention, a home area which a driver of a vehicle travels more frequently than other areas, that is, a home area which the driver travels on a daily basis is stored, and in this home area, congestion levels received from an outside unit are displayed as they are. Moreover, the received congestion levels and speed information related to traveling speeds of the vehicle, for example travel times received simultaneously with the congestion levels, traveling speeds of the vehicle, traveling speeds of another vehicle, or the like are learned in a correlated manner. On the other hand, when the vehicle is outside the home area, the learned congestion levels corresponding to speed information sent from the outside unit at this time are displayed.

Accordingly, when roads are located in either of areas inside and outside the home area, congestion levels of the roads are displayed as congestion levels according to the correlation between congestion levels and speed information in the home area. That is, the driver of the vehicle would recognize the relation between the congestion levels and speed information, which he/she habitually recognizes in his/her home area also at a location outside the home area. Therefore, a sense of discomfort recognized by the driver about the congestion levels displayed on the congestion level display apparatus can be reduced.

Since the congestion levels sent from the outside unit are displayed as they are in the home area, it is possible to suppress increase in load imposed on the congestion level display apparatus.

According to a second aspect of the present invention, in the congestion level display apparatus according to the first aspect, the speed information contained in the congestion information from the outside unit is a travel time needed for traveling the predetermined section of the road, the congestion level learning unit calculates a traveling speed of the vehicle corresponding to the travel time sent from the outside unit and learns the traveling speed and the congestion level in a correlated manner, and when the current position is not within the home area, the display control unit calculates a traveling speed of the vehicle corresponding to the travel time sent from the outside unit and displays a congestion level learned by the congestion level learning unit corresponding to the traveling speed.

According to the second aspect of the present invention, the speed information sent from the outside unit is a travel time. When the vehicle is outside the home area, a traveling speed is calculated from the travel time, and a learned congestion level corresponding to the traveling speed is displayed. Accordingly, the discrepancy recognized by the driver about congestion levels is limited to one due to that different ranges of traveling speeds are set to the same congestion level. Therefore, the discrepancy recognized by the driver outside the home area can be suppressed more securely.

According to a third aspect of the present invention, a congestion level display method for displaying a congestion level indicating a congestion status of a predetermined section of a road, the congestion status correlated with speed information related to a traveling speed when the vehicle travels the predetermined section, includes: detecting, when the speed information and the congestion level sent from an outside unit are received, a current position of the vehicle and obtaining a home area which the vehicle travels more frequently than other traveling areas; thereafter, displaying, when the current position is within the home area, the congestion level sent from the outside unit and learning the speed information of the vehicle and the congestion level sent from the outside unit in a correlated manner; and displaying, when the current position is not within the home area, the learned congestion level corresponding to the speed information sent from the outside unit of the vehicle.

According to the third aspect of the present invention, a home area which a driver of a vehicle travels more frequently than other areas, that is, a home area which the driver travels on a daily basis is learned, and in this home area, congestion levels received from the outside unit are displayed as they are. Moreover, the received congestion levels and speed information related to traveling speeds of the vehicle, for example travel times received simultaneously with the congestion levels, traveling speeds of the vehicle, traveling speeds of another vehicle, or the like are learned in a correlated manner. On the other hand, when the vehicle is outside the home area, the learned congestion levels corresponding to the speed information at this time are displayed.

Accordingly, when roads are located in either of areas inside and outside the home area, congestion levels of the roads are displayed as congestion levels according to the correlation between congestion levels and speed information in the home area. That is, the driver of the vehicle would recognize the relation between the congestion levels and speed information, which he/she habitually recognizes in his/her home area also at a location outside the home area. Therefore, a sense of discomfort recognized by the driver about the congestion levels displayed on the congestion level display apparatus can be reduced.

Since the congestion levels sent from the outside unit are displayed as they are in the home area, it is possible to suppress increase in load imposed on the congestion level display apparatus.

According to a fourth aspect of the present invention, a congestion level display system includes: a congestion level display apparatus that displays a congestion level indicating a congestion status of a predetermined section of a road, the congestion status correlated with speed information related to a traveling speed when a vehicle travels the predetermined section; and center capable of communicating with the congestion level display apparatus. In the congestion level display system, when the speed information and the congestion level sent from the center are received, the congestion level display apparatus detects a current position of the vehicle and obtains a home area which the vehicle travels more frequently than other traveling areas; thereafter, when the current position is within the home area, the congestion level display apparatus displays the congestion level sent from the center, and learns the speed information of the vehicle and the congestion level sent from the center in a correlated manner; and when the current position is not within the home area, the congestion level display apparatus displays the learned congestion level corresponding to the speed information sent from the center.

According to the fourth aspect of the present invention, a congestion level display apparatus learns a home area which a driver of a vehicle travels more frequently than other areas, that is, a home area which the driver travels on a daily basis, and displays, in this home area, congestion levels received from a center as they are. Moreover, the received congestion levels and speed information related to traveling speeds of the vehicle, for example travel times received simultaneously with the congestion levels, traveling speeds of the vehicle, traveling speeds of another vehicle, or the like are learned in a correlated manner. On the other hand, when the vehicle is outside the home area, the learned congestion levels corresponding to the speed information at this time are displayed.

Accordingly, when roads are located in either of areas inside and outside the home area, congestion levels of the roads displayed by the congestion level display apparatus are congestion levels according to the correlation between congestion levels and speed information in the home area. That is, the driver of the vehicle would recognize the relation between congestion levels and speed information, which he/she habitually recognizes in his/her home area also at a location outside the home area. Therefore, a sense of discomfort recognized by the driver about the congestion levels displayed on the congestion level display apparatus can be reduced.

Since the congestion levels sent from the outside unit are displayed as they are in the home area, it is possible to suppress increase in load imposed on the congestion level display apparatus.

### BRIEF DESCRIPTION OF THE DRAWINGS

FIG. 1 is a diagram schematically illustrating a congestion level display system using a congestion level display apparatus of one embodiment according to the present invention;

FIG. 2 is a block diagram illustrating a schematic structure of the congestion level display apparatus;

FIG. 3 is a flowchart illustrating a procedure of congestion level display processing;

FIG. 4A to FIG. 4C are graphs illustrating distributions of vehicle traveling speeds for respective congestion levels; and

FIG. 5A and FIG. 5B are tables illustrating relations between congestion levels and vehicle traveling speeds.

### DETAILED DESCRIPTION

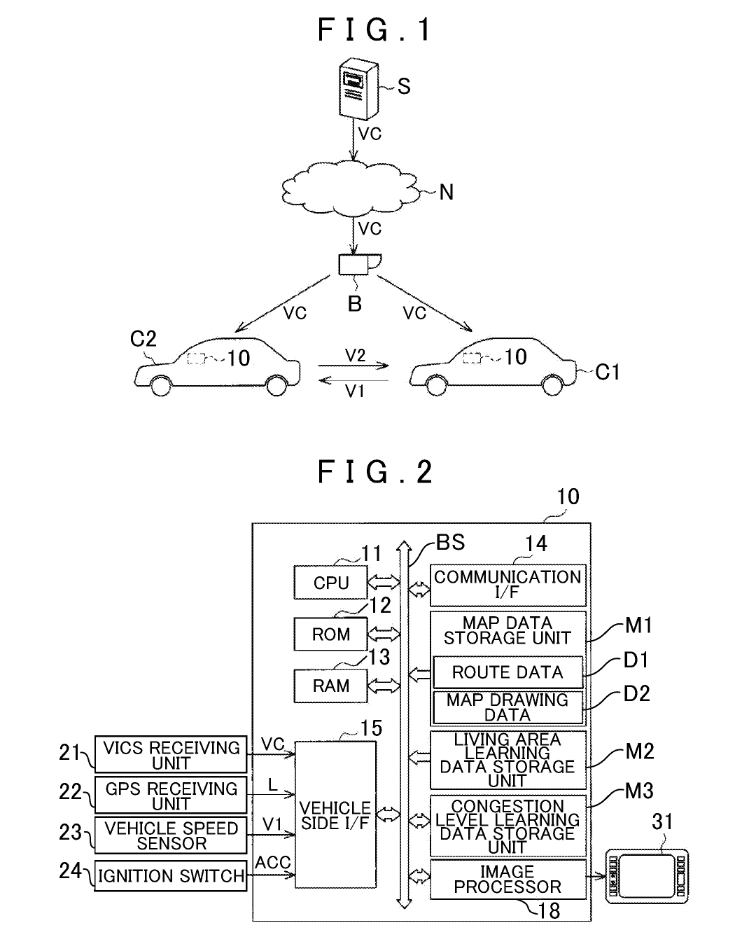

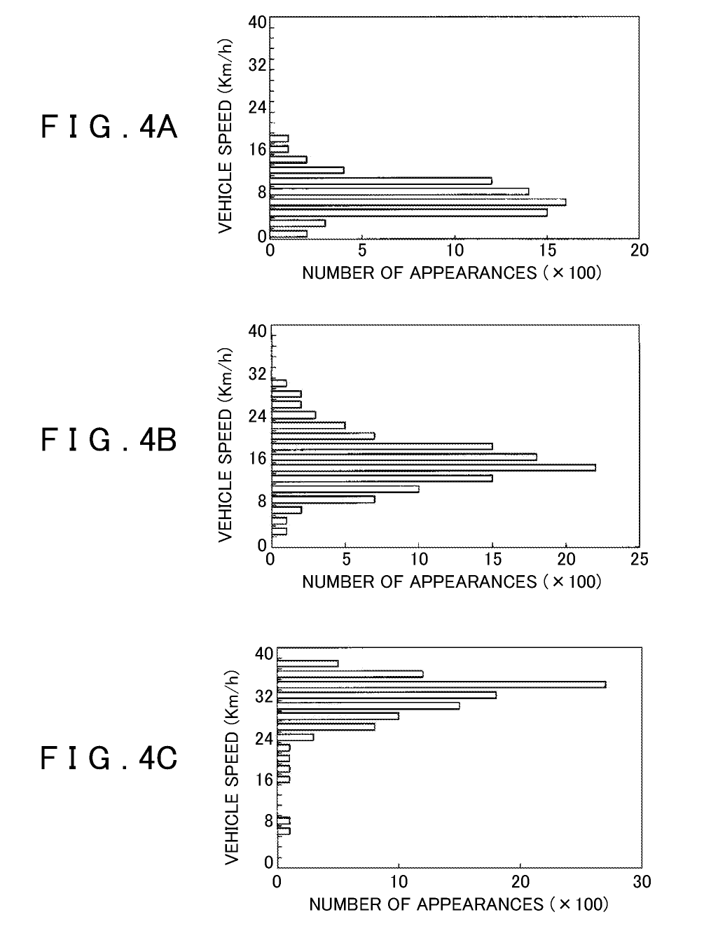

Hereinafter, a congestion level display apparatus according to one or more embodiments of the present invention and a congestion level display method using this apparatus will be described with reference to FIG. 1 to FIG. 3, and FIG. 4A to FIG. 4C.

FIG. 1 schematically illustrates a congestion level display system which uses the congestion level display apparatus embodied as a navigation apparatus mounted in a vehicle and in another vehicle to provide various traffic information including congestion information of a road to these vehicles.

As illustrated in FIG. 1, the congestion level display system has a server S which stores traffic information VC containing congestion information of a road, a necessary time in a predetermined section, a traffic obstruction such as construction, traffic restriction information such as road closure, and parking area information including availability, and so on. As the congestion level display system, for example, a Vehicle Information and Communication System (VICS) can be employed. The server S sends the traffic information VC to a beacon B provided on an ordinary road and an expressway via a network N. The beacon B sends the received traffic information VC to vehicles C1, C2 using a radio wave having a predetermined frequency, light having a predetermined wavelength, or the like. Navigation apparatuses 10 mounted in the vehicles C1, C2 receive the traffic information VC sent from the beacon B as a radio wave, light, or the like. The navigation apparatuses 10 mounted respectively in the vehicles C1, C2 are structured to be capable of sending/receiving traffic information, for example, traveling speeds V1, V2 of the vehicles C1, C2, and the like associated with the navigation apparatuses 10 to/from each other when the distance between the vehicles C1, C2 is within a predetermined range, for example, within a distance of a few hundred meters or a few kilometers. In short, the navigation apparatuses 10 are structured to be capable of performing what is called inter-vehicle communication. Based on the traffic information VC received from the beacon B, the traveling speeds V1, V2 received by the inter-vehicle communication, and the like, the navigation apparatuses 10 output information on, for example, congestion levels indicating congestion statuses of respective roads, and the like as an image or voice.

Next, an electrical structure of the navigation apparatuses 10 provided in the vehicles C1, C2 will be described with reference to FIG. 2. Note that, for convenience, the navigation apparatus 10 mounted in the vehicle C1 will be described.

As illustrated in FIG. 2, the navigation apparatus 10 includes a CPU 11 performing various processing in the navigation apparatus 10, a ROM 12 in which programs related to various processing executed in the CPU 11 are stored in advance, and a RAM 13 in which data generated by executing a program in the CPU 11 are stored temporarily. These CPU 11, ROM 12, and RAM 13 are connected to a same bus BS, and thus are capable of sending/receiving various data to/from each other.

A communication interface (I/F) 14 and a vehicle side interface (I/F) 15 are connected to the bus BS. The communication I/F 14 allows communication between the navigation apparatus 10 and the beacon B and the inter-vehicle communication between the vehicle C1 and the other vehicle C2. A VICS receiving unit 21 is connected to the vehicle side I/F 15, and the traffic information VC containing congestion information received by the VICS receiving unit 21 is inputted to the CPU 11. The congestion information contains, for respective predetermined sections, for example respective links of a road, travel times required for traveling and congestion levels set according to vehicle traveling speeds which can be calculated from the travel times. The congestion levels are classified into “heavy congestion”, “light congestion”, and “no congestion” in descending order of congestion levels of a section, that is, ascending order of vehicle traveling speeds. For example, a congestion status when the vehicle traveling speed is equal to or lower than 10 km/h is set as “heavy congestion”, a congestion status when the vehicle traveling speed is higher than 10 km/h and equal to or lower than 20 km/h is set as “light congestion”, and a congestion status when the vehicle traveling speed is higher than 20 km/h is set as “no congestion”. In addition, different color information is correlated with these three congestion statuses. For example, “red” is assigned to “heavy congestion”, “orange” is assigned to “light congestion”, and “blue” is assigned to “no congestion” as colors indicating the respective statuses.

A Global Positioning System (GPS) receiving unit 22 is connected to the vehicle side I/F 15, and position information L received by the GPS receiving unit 22 is inputted to the CPU 11. In other words, the CPU 11 identifies the current position of the vehicle by electronic navigation. In addition, a vehicle speed sensor 23 is connected to the vehicle side I/F 15, and a traveling speed V1 of the vehicle C1 detected by the vehicle speed sensor 23 is inputted to the CPU 11. In some embodiments, in lieu of the electronic navigation, the CPU 11 may identify the current position by autonomous navigation based on information inputted from the vehicle speed sensor 23 and a gyro sensor (not shown). In further embodiments, the electronic navigation and the autonomous navigation may be used in combination.

Further, an ignition switch 24 is connected to the vehicle side I/F 15, and information (switch information ACC) related to an on/off state of an accessory switch in the ignition switch 24 is inputted to the CPU 11. That is, the CPU 11 determines whether the accessory switch is on or not based on the switch information ACC.

On the other hand, a map data storage unit M1 storing route data D1 and map drawing data D2 is connected to the bus BS. The route data D1 contain link IDs, connection nodes, link costs, and so on. On the one hand, the map drawing data contain data of second-order regional sections (second-order meshes) or fivefold region meshes in the map of the entire nation, background data for drawing the map of the entire nation, road shape data, and so on. The data of the second-order meshes are data of the map of the entire nation divided into sections of about 10 km square, and the data of the fivefold region meshes are data of the map of the entire nation divided into sections of about 5 km square.

A home area learning data storage unit M2 is connected to the bus BS. In this home area learning data storage unit M2, there is stored an area learned by the CPU 11 as a home area of the driver of the vehicle C1, which is an area traveled by the driver more frequently than other traveling areas, based on a traveling trace of the vehicle C1, that is, a trace of the position information L.

Further, a congestion level learning data storage unit M3 is connected to the bus BS. In this congestion level learning data storage unit M3, from the traffic information VC received by the VICS receiving unit 21 in the home area, congestion levels indicating congestion statuses in predetermined sections, for example specific links, of a road and traveling speeds V of the vehicle calculated by the CPU 11 based on travel times of the links are stored in a correlated manner. The above-described RAM, ROM and at least one of the data storage units is/are also referred to herein as a non-transitory computer-readable recording medium that, in some embodiments, includes external/removable and/or internal/built-in storage or memory unit, e.g., one or more of an optical disk, such as a DVD, a magnetic disk, such as a hard disk, a semiconductor memory, such as a memory card, and the like.

A display 31 displaying various images via an image processor 18 is connected to the bus BS. The image processor 18 converts various information related to images, for example the map drawing data D2 and a color correlated with a congestion level into information which can be displayed on the display 31. The color correlated with a congestion level is displayed on the display 31 in such a manner that a road in the congested state is stained with a color corresponding to the congestion level.

The specific description herein will refer to CPU 11 as being programmed for performing various functions in some embodiments. However, in further embodiments, one or more of the functions of CPU 11 described herein is/are performed by specifically configured hardware (e.g., by one or more application specific integrated circuits or ASIC(s)) which is/are provided) separate from CPU 11. Some embodiments incorporate more than one of the described functions in a single ASIC.

As described above, in the congestion level display system, the traffic information VC sent from the server S to the vehicles C1, C2 contains congestion levels of respective predetermined sections, for example respective links of a road. Moreover, this information related to congestion levels is sent to the vehicles C1, C2 as the colors according to the aforementioned congestion levels. Accordingly, in the navigation apparatus 10 which has received congestion levels sent from the server S, the colors according to the congestion levels are outputted in such a manner that the predetermined sections of a road are stained with the colors corresponding to the respective congestion levels. The driver who has visually checked this output screen recognizes the congestion levels of predetermined sections of roads by the colors of the roads.

Now, in the traffic information VC sent from the server S, ranges of vehicle traveling speeds correlated respectively with the three divisions of congestion levels, in other words, a threshold between “heavy congestion” and “light congestion” and a threshold between “light congestion” and “no congestion” often differ depending on the region where roads are provided. For example, in a region A where there are many roads on which the congestion levels tend to be high relatively frequently and speeds of vehicles traveling on these roads tend to be low, there are tendencies that the above-described two thresholds are set to lower speeds than in a region B where there are many roads on which the congestion levels are lower than those in the region A and speeds of vehicles traveling on these roads are high. In other words, vehicle traveling speeds for determining “heavy congestion” and “light congestion” are set in a wider range and/or higher range in the region B than the region A, even for roads of the same class.

Here, the driver of a vehicle is accustomed to the divisions of congestion levels in the region which is his/her own home area. Thus, a driver whose home area is the region A recognizes the congestion status of a road as “light congestion” or “heavy congestion” at lower traveling speeds than a driver whose home area is the region B. Accordingly, when the driver whose home area is the region A, for example, travels a road located in the region B with his/her own vehicle, and the congestion status of a predetermined section of the road is displayed on the navigation apparatus 10 based on the congestion levels contained in the traffic information VC, the driver may recognize a discrepancy between the congestion status which he/she is accustomed to and the displayed congestion status. Specifically, a congestion status recognized by the driver as “no congestion” may be displayed as “light congestion” on the navigation apparatus 10, or a congestion status recognized by the driver as “light congestion” may be displayed as “heavy congestion” on the navigation apparatus 10.

Thus, when a discrepancy occurs between the congestion status of a road recognized by the driver and a congestion status displayed on the navigation apparatus 10, the driver feels a sense of discomfort about the display on the navigation apparatus 10, and furthermore, usefulness of congestion levels displayed on the navigation apparatus 10 for this driver decreases.

Accordingly, the navigation apparatus 10 according to this embodiment learns the home area where the driver travels with his/her vehicle, and learns congestion levels sent from the server S in this home area and vehicle traveling speeds at this time in a correlated manner. When the vehicle is located outside the home area, the navigation apparatus calculates congestion levels from ranges of speeds for respective divisions of the learned congestion levels and vehicle traveling speeds sent from the server S at this time, and displays the thus calculated congestion levels. In other words, ranges of traveling speeds similar to those in the home area are correlated with the divisions of the congestion levels when the vehicle is outside the home area.

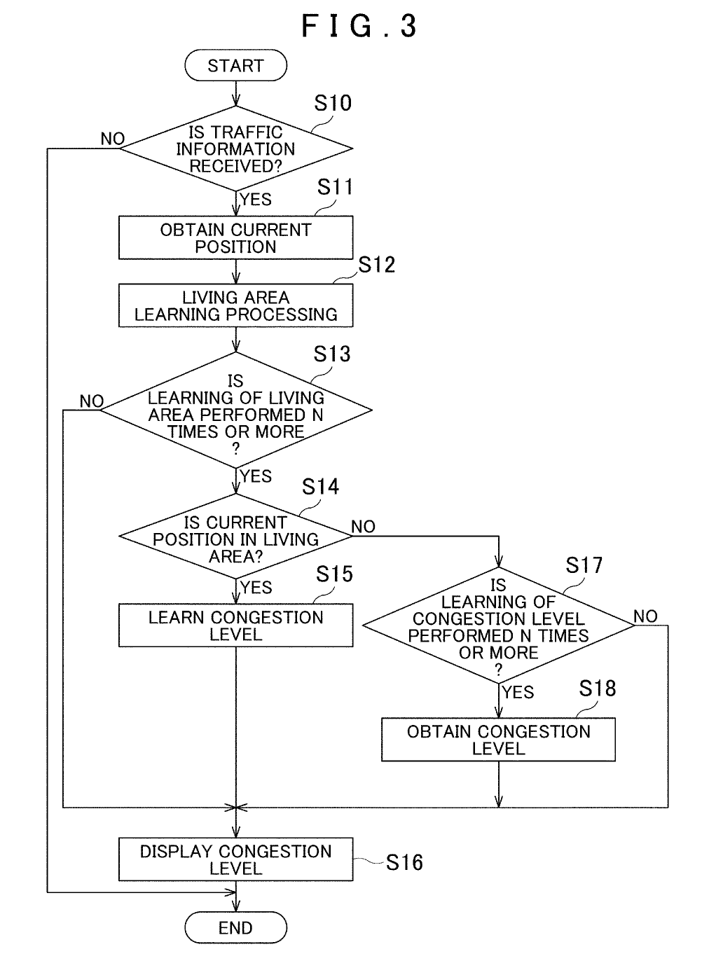

FIG. 3 is a flowchart illustrating a procedure related to processing of displaying congestion levels, and this processing is performed by the CPU 11 provided in the navigation apparatus 10. The congestion level display processing is performed at a predetermined interval from the moment the accessory switch in the ignition switch 24 is switched from off to on until the accessory switch is switched to off again.

In the congestion level display processing, first, when the traffic information VC sent from the server S is obtained by the VICS receiving unit 21 of the navigation apparatus 10 (step S10: YES), the current position of the vehicle C1 is obtained based on the position information L inputted from the GPS receiving unit 22 (step S11). Then, processing of learning the home area is performed (step S12), and a result of learning the home area is stored in the home area learning data storage unit M2. Specifically, the number of appearances of the current position obtained in previous step S11 in each section of the second-order mesh or the fivefold mesh and the number of all current positions are each summed up. A section which meets at least one of the following conditions (A) and (B), for example, is determined and learned as the home area.

(A) A section in which a number of current positions equal to or more than 5% of all the current positions appears is considered to belong to the home area. For example, assume that the navigation apparatus 10 has obtained 100 current position appearances. Then, a section with 5 (5% of 100) or more current position appearances is considered as belonging to the home area. The home area may include more than one of such section.

(B) Among all sections in which the current position has appeared, sections with current position appearance numbers of at least 90% of the largest number of current position appearances in a single section are considered to belong to the home area. For example, assume that there are 10 sections with respective numbers of current position appearances from 1 to 10. The largest number of current position appearances in a single section is 10. Then, the sections with at least 9 (90% of 10) current position appearances are considered to belong to the home area. Namely, the sections with 9 and 10 current position appearances are considered to belong to the home area

The number of current position appearances in each section and the number of all current positions are summed up in step S12 and are added up every time the processing of step S12 is performed, and a determination of the home area is performed with these added-up values on the condition of (A) and/or (B). That is, as the number of times the processing of step S12 is performed increases, the accuracy in identification of the home area also improves.

When the processing of learning the home area in previous step S12 has been performed N times or more (step S13: YES), it is determined whether the current position obtained in previous step S11 is in the home area or not (step S14). The number of times of the learning processing in step S13 is set to a number with which the accuracy in identification of the home area can be guaranteed when the home area is determined on the condition (A) and/or (B).

When the traveling route of the vehicle is within the home area (step S14: YES), the congestion levels contained in the traffic information VC obtained in previous step S10 are learned (step S15). More specifically, in learning of the congestion levels, color information corresponding to “heavy congestion”, “light congestion”, and “no congestion”, which are divisions of the congestion levels contained in the obtained traffic information VC, and vehicle traveling speeds calculated from the travel times contained in the obtained traffic information VC are stored in a correlated manner. FIG. 4A to FIG. 4C illustrate relations between the congestion levels and the vehicle traveling speeds which are stored when the vehicle is traveling in the home area. FIG. 4A to FIG. 4C illustrate distributions of the traveling speeds when the congestion levels are “heavy congestion”, “light congestion”, and “no congestion” in this order, respectively. As illustrated in FIG. 4A to FIG. 4C, regarding all the congestion levels, the maximum value of the number of appearances is in the vicinity of the median of the speed distribution thereof. In this step S15, the traffic information VC contains information regarding plural links as well as travel times and congestion levels related to the respective links, and thus plural relations between the respective congestion levels and the traveling speeds are obtained by one time of processing. However, it may be structured such that only one relation between the respective congestion levels and the traveling speeds is obtained by one time of processing of step S15. The relations between the divisions of the congestion levels and the traveling speeds are updated every time the processing of step S15 is repeated.

Then, by calculating the threshold between “heavy congestion” and “light congestion” and the threshold between “light congestion” and “no congestion” by publicly known statistical processing from these speed distributions, the vehicle traveling speeds corresponding to “heavy congestion”, “light congestion”, and “no congestion” which are habitually recognized by the driver of the vehicle in which the navigation apparatus 10 is mounted are calculated. According to the speed distributions of FIG. 4A to FIG. 4C, for example, the range from 0 km/h or higher to 10 km/h or lower is set as “heavy congestion”, the range from higher than 10 km/h to 22 km/h or lower is set as “light congestion”, and the range higher than 22 km/h is set as “no congestion”.

When the processing of learning the congestion levels in step S15 is completed, the colors according to the congestion levels contained in the traffic information VC obtained in previous step S10 are displayed on the display 31 in such a manner that the roads are stained with the colors corresponding to the respective congestion levels (step S16).

On the other hand, when it is determined in previous step S14 that the current position obtained in step S11 is not within the home area (step S14: No), it is determined whether or not the processing of learning the congestion levels in previous step S15 has been performed N times or more (step S17), wherein N in step S17 may be the same as or different from N in step S13. The number of times of the learning processing set in step S17 is set so that the numbers of appearances of the congestion levels in the respective divisions illustrated in FIG. 4A to FIG. 4C become numbers with which the thresholds calculated in aforementioned step S15 become statistically significant.

When it is determined that the processing of learning the congestion levels in previous step S15 has been performed N times or more (step S17: YES), a traveling speed (e.g., an expected traveling speed of the vehicle) is calculated from the travel times contained in the traffic information VC obtained in previous step S10, and the congestion level corresponding to this traveling speed is obtained from the congestion levels learned in previous step S15. Specifically, when the calculated traveling speed of the vehicle is 12 km/h, for example, and “heavy congestion” is correlated as a division of a congestion level, “light congestion” is obtained as the division of the congestion level based on data stored in the congestion level learning data storage unit M3. When the calculated traveling speed is 24 km/h and “light congestion” is correlated as a division of a congestion level, “no congestion” is obtained as the division of the congestion level based on the same data.

Then, according to the division of the congestion level determined in step S18, the color according to the congestion level is outputted to the display 31 in such a manner that the road is stained with this color.

### Example

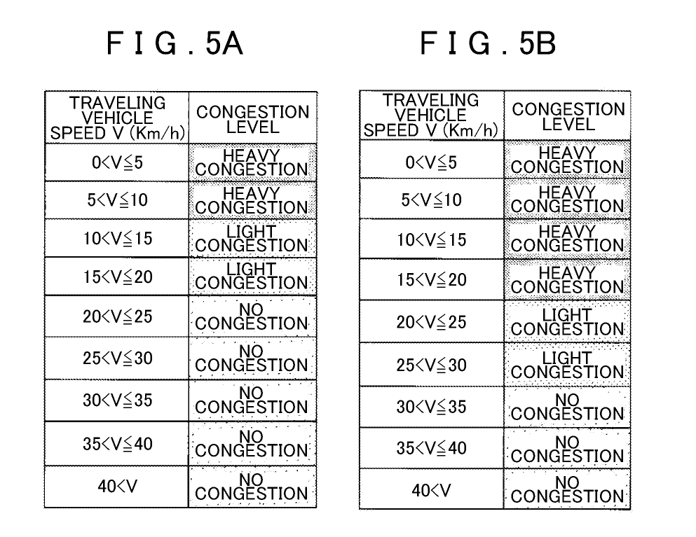

FIG. 5A and FIG. 5B are tables illustrating relations between the divisions of the congestion levels learned in the congestion level learning processing and the vehicle traveling speeds corresponding to these divisions, that is, congestion level learning data. For example, the relation between the divisions of the congestion levels and the traveling speeds when the home area learned in step S13 is the region A is illustrated in FIG. 5A, and the relation between the divisions of the congestion levels and the traveling speeds when the home area is the region B is illustrated in FIG. 5B. Note that in FIG. 5A and FIG. 5B, the vehicle traveling speeds are shown in 5 km/h intervals, and the divisions of the congestion levels correlated with respective speed ranges are shown.

In the region A where road congestions occur relatively frequently, the congestion level is set to “heavy congestion” only when the vehicle traveling speed is in the range from 0 km/h or higher to 10 km/h or lower. On the other hand, in the region B where road congestions occur relatively infrequently, the congestion level is set to “heavy congestion” when the traveling speed is in the range from 0 km/h or higher to 20 km/h or lower. In the region A, the congestion level is set to “light congestion” when the traveling speed is in the range from higher than 10 km/h to 20 km/h or lower, and the congestion level is set to “no congestion” for all traveling speeds in the range higher than 20 km/h. On the other hand, in the region B, the congestion level is set to “light congestion” when the traveling speed is in the range from higher than 20 km/h to 30 km/h or lower, and the congestion level is set to “no congestion” for all traveling speeds in the range higher than 30 km/h. In this manner, the set congestion levels when the traveling speed is in the range from higher than 10 km/h to 30 km/h or lower do not match between the region A and the region B. Here, it is assumed that the relations between the learned congestion levels and the vehicle traveling speeds are equal to the relations between the congestion levels and the traveling speeds sent from the server S for the respective regions. In this case, when a driver whose home area is the region A travels the region B with his/her vehicle, if a congestion level sent from the server S is displayed as sent from the server S on the display 31 of the navigation apparatus 10, there occurs a discrepancy between the congestion level to which the driver is accustomed and the displayed congestion level when the traveling speed is in the range from higher than 10 km/h to 30 km/h or lower. On the other hand, a similar situation happens when a driver whose home area is the region B travels the region A with his/her vehicle.

When the driver whose home area is the region A travels a road in the region B which is not within his/her home area, the above-described navigation apparatus 10, for displaying a congestion level, first receives information from an outside unit, more exactly the traffic information VC sent from the server S via the beacon B. At this time, since the current position of the vehicle is outside the home area, a congestion level contained in the received traffic information VC is not displayed on the display 31, and a congestion level to be displayed on the display 31 is determined from a vehicle traveling speed calculated from the travel times contained in the traffic information VC and the congestion level learning data illustrated in the table of FIG. 5A. For example, when the traveling speed is 14 km/h, although the received congestion level is “heavy congestion”, the congestion level to be displayed on the display 31 is “light congestion”. When the traveling speed is 27 km/h, although the received congestion level is “light congestion”, the congestion level to be displayed on the display 31 is “no congestion”.

On the other hand, when the driver whose home area is the region B travels a road in the region A, the navigation apparatus 10 determines a congestion level to be displayed on the display 31 from the traveling speed calculated from the travel times contained in the received traffic information VC and the congestion level learning data illustrated in the table of previous FIG. 5B. For example, when the traveling speed is 18 km/h, although the received congestion level is “light congestion”, the congestion level to be displayed on the display 31 is “heavy congestion”. When the traveling speed is 30 km/h, although the received congestion level is “no congestion”, the congestion level to be displayed on the display 31 is “light congestion”.

As described above, one or more of the effects listed below can be achieved by using the congestion level display method and the navigation apparatus according to this embodiment.

(1) The home area in which the driver of a vehicle travels more frequently than other areas (e.g., the home area in which the driver travels on a daily basis) is learned, and in this home area,

(a) the congestion levels sent from the server S are displayed as they are, and

(b) the received congestion levels and the vehicle traveling speeds (e.g., as calculated from the travel times received simultaneously with the congestion levels) are learned in a correlated manner.

On the other hand, when the vehicle is outside the home area,

(c) the aforementioned learned congestion levels corresponding to the traveling speeds (e.g., as calculated from the travel times sent from the server S) are displayed. Accordingly, either inside or outside the home area, the congestion levels according to the correlation between the congestion levels and speed information in the home area are displayed on the display 31. That is, the driver of the vehicle would recognize the relation between the congestion levels and the traveling speeds, which he/she habitually accustomed to in his/her home area, also at a location outside the home area. Therefore, a chance that the diver may feel discomfort about the congestion levels displayed on the display 31 of the navigation apparatus 10 can be reduced.

(2) Since the congestion levels sent from the server S are displayed as they are in the home area, it is possible to suppress an increase in load imposed on the navigation apparatus 10.

(3) The travel times sent from the server S, more exactly the vehicle traveling speeds calculated based on the travel times, are correlated with both the congestion levels learned in the home area and the congestion levels learned outside the home area. Accordingly, any discrepancy that the driver may recognize about the congestion levels inside and outside the home area is suppressed, because different ranges of travel times are set to the same congestion level.

It should be noted that the above-described embodiment can be appropriately modified and implemented as follows.

The traffic information VC received by the vehicle is not limited to one sent from the server S which the VICS has, as long as it contains congestion information such as the congestion levels and the travel times of roads.

The traffic information VC sent from the server S is sent through the beacon B of various types. However, this is not restrictive, and the traffic information VC may be sent to the navigation apparatus 10 of the vehicle by any other system, such as FM multiplex broadcasting.

As the divisions of the congestion levels, “heavy congestion” is correlated with “red”, “light congestion” with “orange”, and “no congestion” with “blue”. However, this is not restrictive, and other colors (or any other visually recognizable indicia) can be selected appropriately as long as different colors (or any other visually recognizable indicia) are correlated with the respective different divisions. Likewise, two or more than three levels of congestion levels can be used.

An area which meets one of the conditions (A) and (B) is determined as the home area. However, this is not restrictive, and any method can be employed appropriately as long as it is a method capable of identifying the home area as an area in which a vehicle travels more frequently than other areas.

The congestion levels of roads are displayed on the display 31 of, the navigation apparatus 10 in such a manner that a road for which a congestion level is given is stained with the color corresponding to the congestion level. However, this is not restrictive, and for example, the congestion levels may be displayed as an arrow which indicates a traveling direction, is displayed on the road or in the vicinity of the road, or the like, and is stained with the color corresponding to the congestion level of the road. In short, it may be any method that displays a road and the color (or any other visually recognizable indicium) indicating the congestion level of this road in a correlated manner on the display 31.

In the processing of learning the home area, the congestion levels sent from the server S and the vehicle traveling speeds calculated from the travel times which are likewise sent from the server S are correlated. However, this is not restrictive, and the congestion levels may be correlated with speed information such as the traveling speed V1 of the vehicle as detected by the vehicle speed sensor 23 or average speeds of the traveling speeds V1, V2 obtained from one or more other vehicles by the above-described inter-vehicle communication.

Plural items of the speed information may be used in combination. For example, when the travel times are contained in the traffic information VC sent from the server S, the traveling speeds calculated from the travel times are correlated with the congestion levels. When no travel time is contained in the traffic information VC, the traveling speeds of the vehicle on which the navigation apparatus is installed or traveling speeds of other vehicles are correlated with the congestion levels.

At a location outside the home area, the congestion levels are determined from the traveling speeds corresponding to the respective divisions of the learned congestion levels and the vehicle traveling speeds calculated from the travel times. However, this is not restrictive, and traveling speeds of one or more other vehicles obtained by the inter-vehicle communication may be used as the traveling speeds used when the congestion levels are determined. The traveling speeds of the vehicle on which the navigation apparatus is installed may also be used for determining the appropriate congestion level to be displayed.

The home area of the driver of the vehicle is learned. However, this is not restrictive, and for example, a predetermined range from the address of the driver, or the like may be set as the home area, and this home area may be stored in advance in the ROM 12 or the home area learning data storage unit M2.

The home area of the driver of the vehicle is learned. However, this is not restrictive, and for example, a predetermined range from the address of the driver, or the like may be set as the home area, and the ROM 12 or the home area learning data storage unit M2 may store this home area in advance. Then it may be structured such that the CPU 11 obtains data related to the home area stored in the ROM 12 or the home area learning data storage unit M2, and the above-described processing of displaying the congestion levels is performed by the CPU 11.

What is claimed is:

1. A congestion level display apparatus for installation in a vehicle and for displaying a congestion level of a road section in relation to la traveling speed when the vehicle travels the road section, the apparatus comprising:
a receiving unit for receiving congestion information for the road section from an outside unit;
a position detecting unit for detecting a current position of the vehicle;
a determining unit for determining whether the current position is within a home area of the vehicle;
a congestion level learning unit for, when the current position is within the home area, learning a correlation between (i) the traveling speed in the road section and (ii) a congestion level in the congestion information sent from the outside unit; and
a display control unit for displaying,
when the current position is within the home area, the congestion level sent from the outside unit, and
when the current position is not within the home area, a congestion level determined by the correlation as corresponding to the traveling speed in the road section.

2. The congestion level display apparatus according to claim 1, wherein
the congestion information from the outside unit further includes a travel time needed for traveling the road section,
the congestion level learning unit is arranged to calculate a traveling speed from the travel time sent from the outside unit, and learn the correlation between the calculated traveling speed and the congestion level sent from the outside unit, and
when the current position is not within the home area, the display control unit is arranged to calculate a traveling speed from the travel time sent from the outside unit, and display a congestion level determined by the correlation as corresponding to the calculated traveling speed.

3. The congestion level display apparatus according to claim 1, wherein
the congestion information from the outside unit further includes speed information for the road section,
the congestion level learning unit is arranged to determine a traveling speed from the speed information sent from the outside unit, and learn the correlation between the determined traveling speed and the congestion level sent from the outside unit, and
when the current position is not within the home area, the display control unit is arranged to determine a traveling speed from the speed information sent from the outside unit, and display a congestion level determined by the correlation as corresponding to the determined traveling speed.

4. The congestion level display apparatus according to claim 1, further comprising
a speed sensor for sensing a traveling speed of the vehicle,
the congestion level learning unit is arranged to learn the correlation between the sensed traveling speed and the congestion level sent from the outside unit, and
when the current position is not within the home area, the display control unit is arranged to display a congestion level determined by the correlation as corresponding to the sensed traveling speed.

5. The congestion level display apparatus according to claim 1, further comprising
an inter-vehicle communication interface for receiving at least a traveling speed of another vehicle,
the congestion level learning unit is arranged to learn the correlation between the received traveling speed and the congestion level sent from the outside unit, and
when the current position is not within the home area, the display control unit is arranged to display a congestion level determined by the correlation as corresponding to the received traveling speed.

6. The congestion level display apparatus according to claim 5, further comprising
a speed sensor for sensing a traveling speed of the vehicle,
the congestion level learning unit is arranged to determine a traveling speed from the sensed traveling speed of the vehicle and the received traveling speed of said another vehicle, and learn the correlation between the determined traveling speed and the congestion level sent from the outside unit, and
when the current position is not within the home area, the display control unit is arranged to determine a traveling speed from the sensed traveling speed of the vehicle and the received traveling speed of said another vehicle, and display a congestion level determined by the correlation as corresponding to the determined traveling speed.

7. The congestion level display apparatus according to claim 1, further comprising
a speed sensor for sensing a traveling speed of the vehicle,
wherein when the congestion information from the outside unit further includes speed information for the road section,
the congestion level learning unit is arranged to determine a traveling speed from the speed information sent from the outside unit, and learn the correlation between the determined traveling speed and the congestion level sent from the outside unit, and
wherein when the congestion information from the outside unit does not include speed information for the road section,
the congestion level learning unit is arranged to learn the correlation between the sensed traveling speed and the congestion level sent from the outside unit.

8. The congestion level display apparatus according to claim 1, further comprising
an inter-vehicle communication interface for receiving at least a traveling speed of another vehicle,
wherein when the congestion information from the outside unit further includes speed information for the road section,
the congestion level learning unit is arranged to determine a traveling speed from the speed information sent from the outside unit, and learn the correlation between the determined traveling speed and the congestion level sent from the outside unit, and
wherein when the congestion information from the outside unit does not include speed information for the road section,
the congestion level learning unit is arranged to learn the correlation between the received traveling speed and the congestion level sent from the outside unit.

9. The congestion level display apparatus according to claim 1, further comprising
a home area learning unit for learning the home area as an area in which the vehicle travels more frequently than in other areas.

10. The congestion level display apparatus according to claim 1, further comprising
a home area storage unit for storing an address and a vicinity of said address as the home area.

11. A congestion level display method for displaying, to a driver of a vehicle, a congestion level of a road section in relation to a traveling speed in the road section, the method comprising:
detecting a current position of the vehicle and determining whether the current position is within a home area of the vehicle;
when the current position is within the home area,
displaying a congestion level sent from an outside unit, and
learning a correlation between (i) the traveling speed in the road section and (ii) the congestion level sent from the outside unit in a correlated manner; and
when the current position is not within the home area,
displaying a learned congestion level determined by the correlation as corresponding to the traveling speed in the road section.

12. The congestion level display method according to claim 11, further comprising
determining the traveling speed in the road section based on at least one of speed information sent from the outside unit, a sensed speed of the vehicle, or a speed of another vehicle received via inter-vehicle communication.

13. The congestion level display method according to claim 12, wherein
when the speed information is sent from the outside unit, said learning uses the traveling speed determined based on the speed information sent from the outside unit for said correlation, and
when the speed information is not sent from the outside unit, said learning uses the traveling speed determined based on at least one of the sensed speed of the vehicle or the speed of another vehicle for said correlation.

14. The congestion level display method according to claim 11, wherein said detecting is performed upon receipt of the congestion level sent from the outside unit.

15. The congestion level display method according to claim 11, further comprising
learning the home area as an area in which the vehicle travels more frequently than in other areas.

16. The congestion level display method according to claim 15, further comprising
performing said learning the home area a predetermined number of times before displaying the congestion level based on whether or not the current position is within the home area, and
before said learning the home area has been performed the predetermined number of times, displaying the congestion level as sent from the outside unit without performing said learning the correlation.

17. The congestion level display method according to claim 11, further comprising
storing an address, and
setting said address and a vicinity of said address as the home area.

18. The congestion level display method according to claim 11, further comprising
performing said learning the correlation a predetermined number of times before displaying the congestion level based on said correlation, and
before said learning the correlation has been performed the predetermined number of times, displaying the congestion level as sent from the outside unit regardless of whether or not the current position is within the home area.

19. The congestion level display method according to claim 18, further comprising
selecting the predetermined number of times so that the correlation becomes statistically significant after said learning the correlation has been performed the predetermined number of times.

20. A congestion level display system, comprising:
a congestion level display apparatus for installation in a vehicle and for displaying a congestion level of a road section in relation to a traveling speed in the road section; and
a traffic center communicable with the congestion level display apparatus,
wherein the congestion level display apparatus comprises a processor configured for
detecting a current position of the vehicle and determining whether the current position is within a home area of the vehicle;
when the current position is within the home area, displaying the congestion level sent from the traffic center, and learning a correlation between (i) the traveling speed in the road section and (ii) the congestion level sent from the traffic center; and
when the current position is not within the home area, displaying a learned congestion level determined by the correlation as corresponding to the traveling speed in the road section.
